(19) United States
(12) Patent Application Publication
(10) Pub. No.: US 2007/0036074 A1
(43) Pub. Date: Feb. 15, 2007

(54) PACKET TRANSMISSION METHOD FOR WLAN

(76) Inventors: Tzu-Jane Tsai, Hsinchu County (TW); Ju-Wei Chen, Hsinchu City (TW); Hsueh-Wen Tseng, Taipei County (TW); Ai-Chun Pang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,057

(22) Filed: Dec. 15, 2005

(30) Foreign Application Priority Data
Aug. 15, 2005 (TW) 94127683

(51) Int. Cl. H04L 12/26

(52) U.S. Cl. 370/229; 370/338; 370/401

(57) ABSTRACT

A packet transmission method for WLAN, a controlling method for data transmitting node of WLAN and a controlling method for data receiving node of WLAN are provided. In the packet transmission method, the data transmitting node sends a transmitting request signal. When the receiving node receives the transmitting request signal and cannot immediately perform a transmitting operation defined by the transmitting request signal, a stop-transmitting signal is sent to the transmitting node. After sending the stop-transmitting signal, the receiving node outputs a start-to-transmit signal to the transmitting node when the transmitting operation can be performed. The transmitting node sends the data after receiving the start-to-transmit signal.

### CROSS-REFERENCE TO RELATED APPLICATION

This application claims the priority benefit of Taiwan application serial no. 94127683, filed on Aug. 15, 2005. All disclosure of the Taiwan application is incorporated herein by reference.

### BACKGROUND OF THE INVENTION

1. Field of the Invention

This invention generally relates to a controlling method for network transmission, and especially to a packet transmitting method for WLAN, a controlling method for dada transmitting node of WLAN and a controlling method for data receiving node of WLAN.

2. Description of Related Art

The design of a wireless local area network (WLAN), is based on a cellular architecture. The whole network system comprises multiple cells, and each cell is a basic service set controlled by a base station, which is also an access point. The complete connected WLAN comprises each access point and the complete distributed system, which is generally called an extended service set.

In a previous WLAN system, an end user connects a nearby access point in a wireless manner, wherein, each access point is respectively connected with a cable network directly, and the cable network is utilized as data exchange paths among the access points. However, the method not only increases cable distribution cost, but also increases cable distribution difficulty. Further, for those old buildings or outdoor environments without the cable network, it is also very difficult to achieve full wireless network communication in the WLAN system.

In view of the above, the wireless network is now used as data exchange paths among the access points. The Medium Access Control Protocol (MAC protocol) of the standard with number 802.11 from the Institute of Electrical and Electronics Engineers is utilized to transmit data with a Carrier Sense Medium Access/Collision Avoidance (CSMA/CA) manner. When transmitting data in the CSMA/CA manner, whether or not the wireless medium is in use has to be detected first. When the wireless medium is not in use, the data transmission can be performed; on the contrary, when the wireless medium is in use, the data transmission has to be delayed for sometime.

However, since a small amount of wireless mediums are shared by a large amount of data sources, collisions would inevitably occur. In order to solve the problem, a random delay manner is utilized in the CSMA/CA to reduce the collision. Further, control packets, such as request-to-send (i.e. RTS) and clear-to-send (i.e. CTS), etc., are utilized in the MAC protocol for solving the problem of hidden terminal.

Certainly, the above manner is very helpful in developing the wireless network, but there are still some disadvantages. One of the problems is that the MAC protocol utilizes the so-called virtual carrier sense to provide end-users a time reference data of whether the transmitting medium is busy. A network allocation vector (i.e. NAV) is utilized by the virtual carrier detector to record how much time a certain working station needs for performing a data transmitting operation. In the period indicated by the network allocation vector, other nodes have to keep silent and perform a packet transmitting competition function again after the medium (wireless channel) resumes an idle state. Therefore, since each of the nodes needs the channel competition, the packet throughput of the whole network would decrease substantially. Besides, the possibility of the packet collision caused by an effect of the hidden nodes can be increased substantially. In other words, for a packet, it is not ensured that the end-to-end delay time falls within a certain range. For a backhaul network, this is a very serious problem.

### SUMMARY OF THE INVENTION

An object of the present invention is to provide a packet transmitting method for WLAN, wherein a data receiving node actively starts transmitting data to decrease an end-to-end time delay.

Another object of the present invention is to provide a controlling method for data transmitting node of WLAN, to increase network packet throughput by decreasing the possibility of channel competition.

Another object of the present invention is to provide a controlling method for data receiving node of WLAN, to start a data transmission by actively sending out a start-to-transmit signal at idle time.

The present invention provides a packet transmitting method for WLAN, adapted for transmitting data between the data transmitting node and the data receiving node. The packet transmitting method for WLAN comprises the following steps: first, the data transmitting node sending out a transmitting request signal. When the data receiving node receives the transmitting request signal and cannot immediately perform a transmitting operation defined by the transmitting request signal, the data receiving node sends out a stop-transmitting signal to the data transmitting node. After emitting the stop-transmitting signal (Pseudo CTS, CTSp), the data receiving node can send out a start-to-transmit signal to the same data transmitting node when the transmitting operation can be performed. The data transmitting node, after receiving the start-to-transmit signal, sends out the data to the data receiving node.

According to an embodiment of the present invention, when the data receiving node receives a plurality of transmitting request signals sent out by the data transmitting nodes, the data receiving node first stores the transmitting request signals, further sorts out the order of the transmitting operations defined by the transmitting request signals, and according to the rearranged order, sends back the start-to-transmit signal to one of the corresponding data transmitting nodes.

According to the embodiment of the present invention, the above-mentioned control signals such as the transmitting request signal, the stop-transmitting signal, and the start-to-transmit signal, are transmitted through the same wireless channel, and the data is transmitted through another wireless channel. Further, the channel of transmitting the data from the data transmitting node to the data receiving node is a different from the channel of transmitting the data from the data receiving node to another target node.

According to the embodiment of the present invention, the above mentioned stop-transmitting signal does not include a network allocation vector NAV.

The present invention further provides a controlling method for data transmitting node of WLAN, suitable for a data transmitting node that sends out data. The controlling method for data transmitting node of WLAN comprises the following steps: after sending out a transmitting request signal, when a start-to-transmit signal is received allowing for data transmission within a pre-determined time period, starting data transmission; on contrary, when a stop-to-transmit signal is received disallowing data transmission within a pre-determined time period, postponing data transmission until receiving the start-to-transmit signal.

According to the embodiment of the present invention, a clock program of a transmitting control packet is started before sending out the transmitting request signal, and the transmitting request signal is sent out after a time counting process by the clock program is finished. Further, when the start-to-transmit signal and the stop-transmitting signal are not received within a pre-determined time period, the clock program is started again, and the transmitting request signal is sent out again after a time counting process by the clock program is finished.

The present invention further provides a controlling method for data receiving node of WLAN, suitable for a data receiving node which receives data. When the controlling method for data receiving node of WLAN receives a transmitting request signal, but a transmitting operation defined by the transmitting request signal cannot be performed, a stop-transmitting signal is sent out; on the contrary, when the transmitting operation can be performed, a start-to-transmit signal is sent out, and the start-to-transmit signal is sent out for receiving the data.

According to the embodiment of the present invention, after sending out the stop-transmitting signal, the transmitting operation is further rearranged with other transmitting operations in order through a sequencing mechanism, and the rearranged transmitting operation is sequentially performed. Further, the sequencing mechanism performs the rearranging process according to a time delay bound of the transmitting request signal and a class of service.

According to the embodiment of the present invention, whether the transmitting operation can be performed is decided at a time period before a default channel is in an idle state, wherein, the time period is a time required for sending out the start-to-transmit signal.

In summary, the present invention decreases the packet transmitting time delay caused by the channel competition, by utilizing the data receiving node to actively start the data transmitting. Besides, the transmission of the control packet and the transmission of the data are separately performed in different channels, therefore the transmission collision of the packet can be decreased. Furthermore, the end-to-end time delay can be therefore decreased effectively.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF THE DRAWINGS

FIG. 1 is a flow chart of a packet transmitting method for WLAN according to an embodiment of the present invention.

FIG. 2 is a schematic diagram showing a node distribution of WLAN.

FIG. 3 is a schematic diagram showing a protocol state of a controlling method for data transmitting node of WLAN obtained from a packet transmitting method for WLAN according to an embodiment of the present invention.

FIG. 4 is a schematic diagram showing a protocol state of a controlling method for data receiving node of WLAN obtained from a packet transmitting method for WLAN according to an embodiment of the present invention.

FIG. 5 is a schematic diagram showing a wireless network environment formed by linear topology nodes.

FIG. 6 is a schematic diagram showing a wireless network environment formed by interlacing topology nodes.

FIG. 7 is a schematic diagram showing a wireless network environment formed by lattice topology nodes.

FIGS. 8A and 8B are schematic diagrams showing comparison curves of end-to-end throughput and end-to-end time delay, simulated and obtained in a linear topology network environment according to the standard IEEE802.11 and the present invention.

FIGS. 9A and 9B are schematic diagrams showing comparison curves of end-to-end throughput and end-to-end time delay, simulated and obtained in a interlace topology network environment according to the standard IEEE802.11 and the present invention.

FIG. 10A and 10B are schematic diagrams showing comparison curves of end-to-end throughput and end-to-end time delay, simulated and obtained in a lattice topology network environment according to the standard IEEE802.11 and the present invention.

### DESCRIPTION OF THE EMBODIMENTS

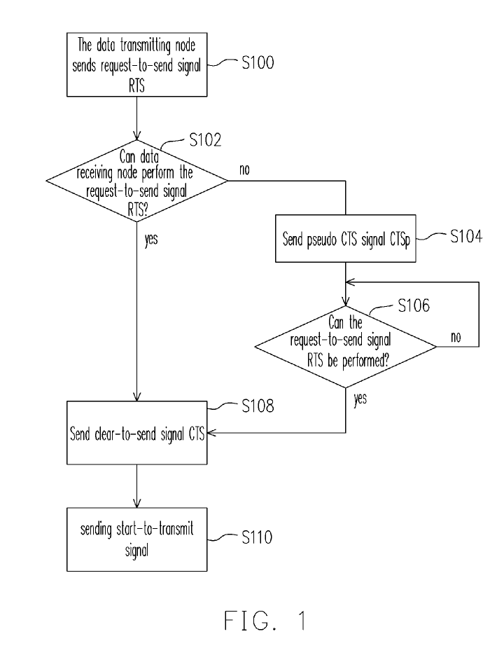

FIG. 1 is a schematic diagram showing a flow chart of a packet transmitting method for WLAN according to an embodiment of the present invention. In the embodiment of the present invention, first, a data transmitting node that sends out data, sends out a request-to-send signal RTS at step S100. A data receiving node that is set to receive the data can decide whether or not to immediately perform a transmitting operation when receiving the request-to-send signal RTS, according to whether or not an idle wireless channel exists in a network environment at step S102.

When an idle wireless channel is detected at step S102, the data receiving node sends out a clear-to-send signal CTS to the above-mentioned data transmitting node at step S108. The data transmitting node, when receiving the clear-to-send signal CTS, can start sending out the data to the data receiving node at step S110.

However, when all of the wireless channels are in a busy state at the step S102, the data receiving node cannot immediately perform the transmitting operation. Meanwhile, the flow goes to step S104. First, the data receiving node sends back a pseudo CTS signal CTSP to the data transmitting node, which sends out the request-to-send signal RTS. The data transmitting node, when receiving the pseudo CTS signal CTSP, temporarily stops trying sending the data to the data receiving node. Whereas, the data receiving node, when the wireless channel is again in an idle state and can therefore perform the transmitting operation at step S106, sends out the above-mentioned clear-to-send signal CTS to the above-mentioned data transmitting node at step S108. Therefore, the data transmitting node starts sending out the data to the data receiving node at step S110.

According to the above-mentioned packet transmitting method for WLAN, the data receiving node can effectively utilize the bandwidth of the wireless network to transmit the data, the channel idle state caused by the channel competition can be decreased, and the packet throughput can be generally increased. Besides, since the channel competition is not necessarily controlled by the data transmitting node, the network allocation vector NAV, which is utilized to record how much time is required for performing data transmitting operation, is not necessarily included in the pseudo CTS signal CTSP sent from the data receiving node to the data transmitting node. Such is a characteristic of the present invention different from the conventional technology.

Further, owing to the progress of the network hardware technology, at least three wireless channels, which do not interfere with each other, can be utilized in the recent wireless network. Furthermore, 12 channels can be utilized in North American according to a standard IEEE802.11a of the Institute of Electrical and Electronics Engineers. Therefore, though an in-band signaling manner is usually utilized in previous technology (such as IEEE 802.11), which means that the control packet and the data packet are transmitted with the same wireless channel, an out-of-band signaling manner is utilized for transmitting the control packet and the data packet in the embodiment of the present invention.

In other words, preferably, a control channel is dedicated to transmit control packets since the control packet is small and the packet collision possibility of the control packet is lower than that of the data packet. Further, in the wireless channel, when the packet collision occurs, the channel competition can be performed also by utilizing the previous IEEE 802.11 manner. Further, except for the wireless channel for transmitting the control packet, called a control channel, all of the other wireless channels, which are called a data channel, can be utilized for transmitting the data. By utilizing the out-of-band signaling manner in conjunction with the packet transmitting method for WLAN as shown in FIG. 1, the control packets such as the request-to-send signal RTS, the pseudo CTS signal CTSP and the clear-to-send signal CTS can be transmitted by the control channel, and the data channel is utilized specially for transmitting the data.

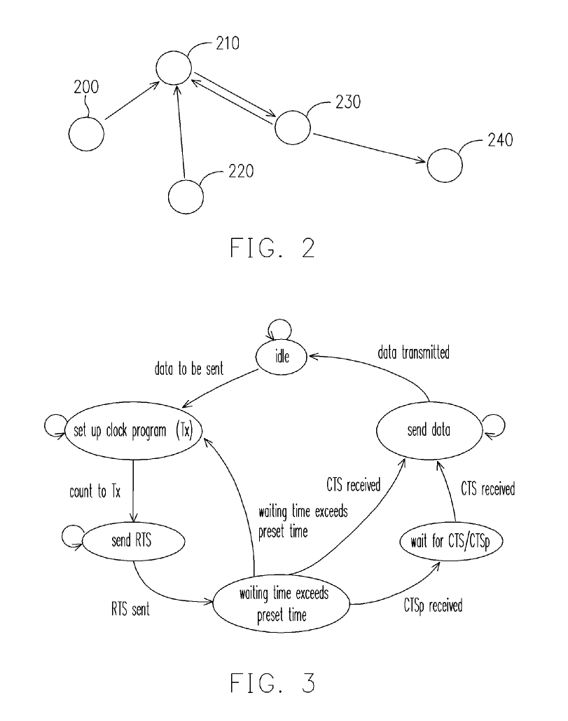

Further, regarding the problem of hidden terminal, the distribution of the data channels is regulated in the embodiment of the present invention. FIG. 2 is a schematic diagram showing node distribution of WLAN. Wherein, nodes 200, 210, 220, 230 and 240 can be the above-mentioned data transmitting nodes and the data receiving nodes. In view of the above, when a data is transmitted from the node 200 to the node 240 and the transmitting path is from the node 200 through the nodes 210, 230 to the node 240, in respect of the distribution of the data channels, the data channel for transmitting the data from the node 200 (corresponding to the data transmitting node) to the node 210 (corresponding to the data receiving node), is preferably different from the data channels for transmitting another data at the same time from the node 210 to another node such as node 220. Therefore, for the node 210, the data can be received and transmitted at the same time, and the data packet throughput can be further increased relatively.

Certainly, during data transmission in the wireless network, there is an inevitable situation where multiple data transmitting nodes transmit data to the same data receiving node at the same time. In order to solve the problem, the present invention, besides the above-mentioned packet transmitting method for WLAN, further provides a sequencing mechanism. As shown in FIG. 2, when all of the nodes 200, 220 and 230 are to transmit data to the node 210 and all of the data channels which can be utilized by the node 210 are occupied, then, the node 210, when receiving the request-to-send signals RTS sent from the nodes 200, 220 and 230, can store the request-to-send signals RTS, and performs a rearranging process to the transmitting operations defined by the request-to-send signals RTS, and finally, when the data channels are in an idle state, sends out the clear-to-send signal CTS to the corresponding nodes one by one according to the rearranged order, for transmitting the data.

Wherein, the priority of data transmission of the sequencing mechanism according to a time delay bound, a class of service or both, therefore, a requirement of end-to-end time delay of different packets can be considered while rearranging the order.

FIG. 3 is a schematic diagram showing a protocol state of a controlling method for data transmitting node of WLAN obtained from the packet transmitting method for WLAN according to an embodiment of the present invention. Wherein, Tx is a time required for the hardware to start the control packet transmission. As shown in FIG. 3, the data transmitting node is at idle state when no data is to be transmitted or processed. When there is data to be transmitted, the hardware starts the clock program of the transmitting control packet for calculating the time Tx. When the calculating period is due, the data transmitting node sends out the control packet RTS, and waits for the data receiving node to send the CTS or the CTSP. When the reply packets which comprise the CTS and the CTSP are still not received after the pre-determined time, the time Tx is reset. When the CTS is received, the data transmitting node loads and sends the data. But when the CTSP is received, the data transmitting node is at a waiting state, and loads and sends the data when the CTS is received.

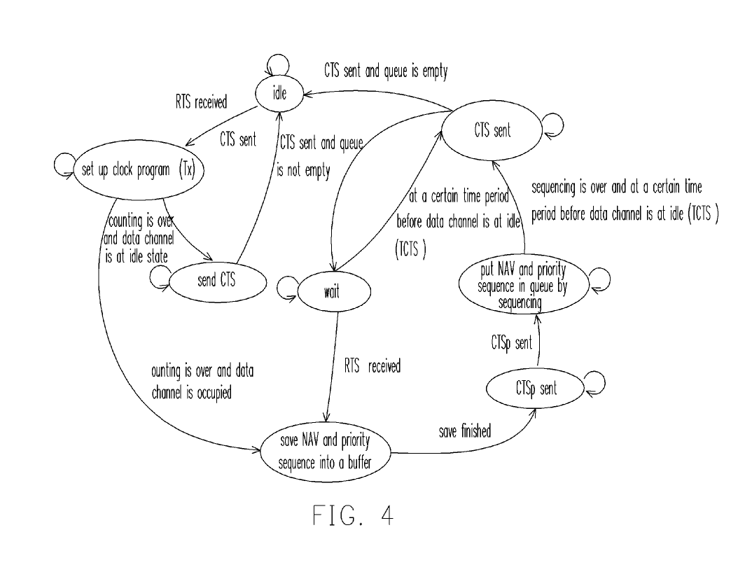

FIG. 4 is a schematic diagram showing a protocol state of a controlling method for data receiving node of WLAN obtained from a packet transmitting method for WLAN according to an embodiment of the present invention. As shown in FIG. 4, in the embodiment of the present invention, the data receiving node is at idle state when no data is received; when receiving the RTS, the hardware starts the clock program of the transmitting control packet. When the calculating period is due, and the data channel to be used is at the idle state, the data receiving node sends the control packet CTS and goes back to the idle state. On the contrary, when the calculating period is due, and the data channel to be used is busy (i.e. occupied), the data receiving node stores the information in the RTS, which comprises the NAV and the priority sequence, and then sends the CTSP. Further, according to the NAV and the priority sequence, and by utilizing the sequencing mechanism, the addresses of the data transmitting nodes are placed in order with first come first out manner. The data channel to be used can send the CTS to the next node which is waiting to send out data, at a certain time period before the recent data transmission is over, wherein, the earliest time period is before TCTS, which is the time required for sending the CTS. When no data transmitting node is at waiting state in the queue, the data receiving node goes back the idle state; on contrary, when there are data transmitting nodes at waiting state in the queue, the data receiving node goes into the waiting state. When receiving new RTS, the data receiving node repeats the above-mentioned NAV storing and the priority sequencing operations, or emits the CTS to the next node which waits for a transmitting process, at the certain time period before the recent data transmission is over, wherein, the earliest time period is before TCTS.

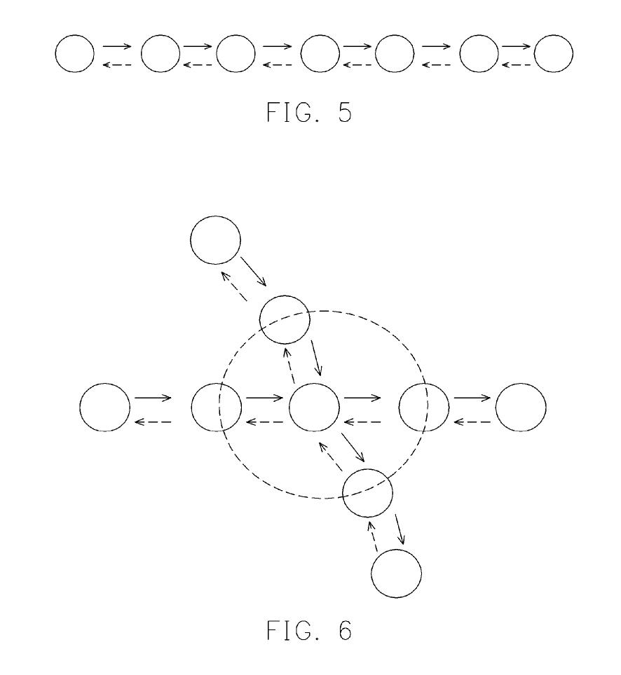

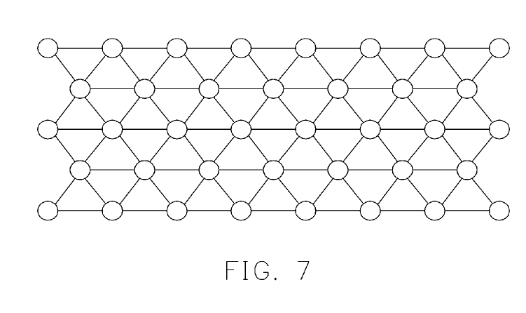

For those skilled in the art to understand the effect of the method of the present invention, several simulating test results are attached. FIG. 5 is a schematic diagram of a wireless network environment formed by linear topology nodes. FIG. 6 is a schematic diagram showing a wireless network environment formed by interlace topology nodes. FIG. 7 is a schematic diagram showing a wireless network environment formed by lattice topology nodes. The tests are respectively performed in the wireless network environments as shown in FIG. 5, FIG. 6 and FIG. 7. The simulation conditions and parameters are as follows:

Activate node to generate Poisson traffic.

Mean arrival rate: 10 to 250 packets/per second.

Simulation duration: 200 seconds.

RTS/CTS transmission rate: 1 million bits per second.

Data transmission rate: 2 million bits per second.

Signal broadcast delay: 33.33 nano seconds.

Tx: 25μ second.

Time slot between two packets: 1μ second.

Control packet size: 128 bits.

Data packet size: 2048 bits.

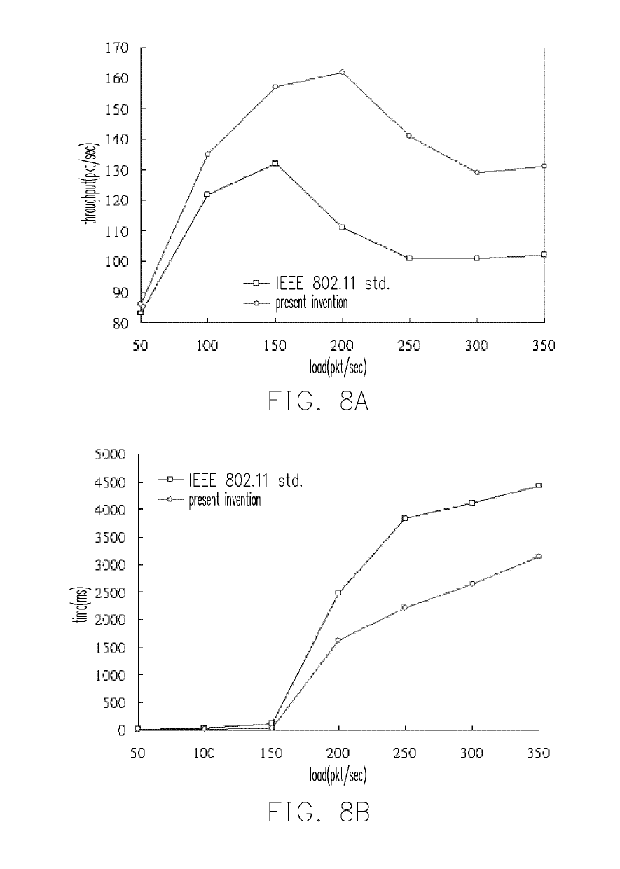

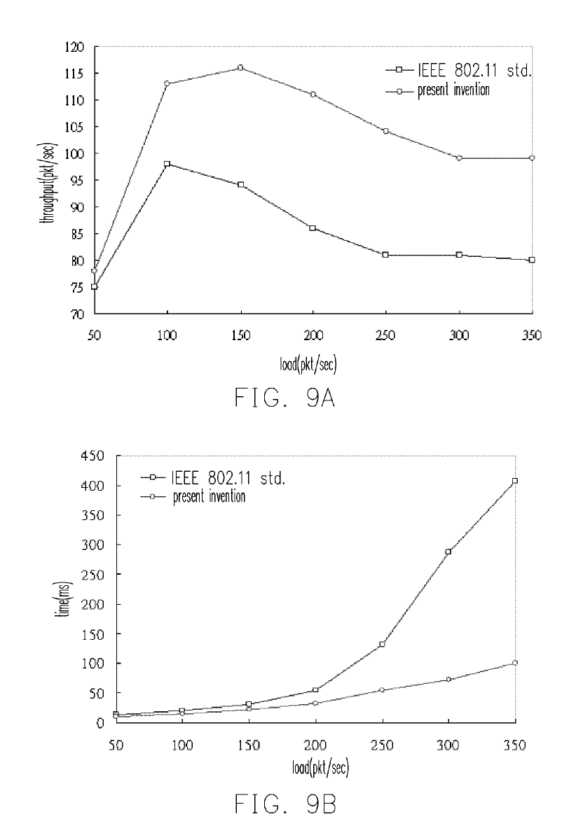

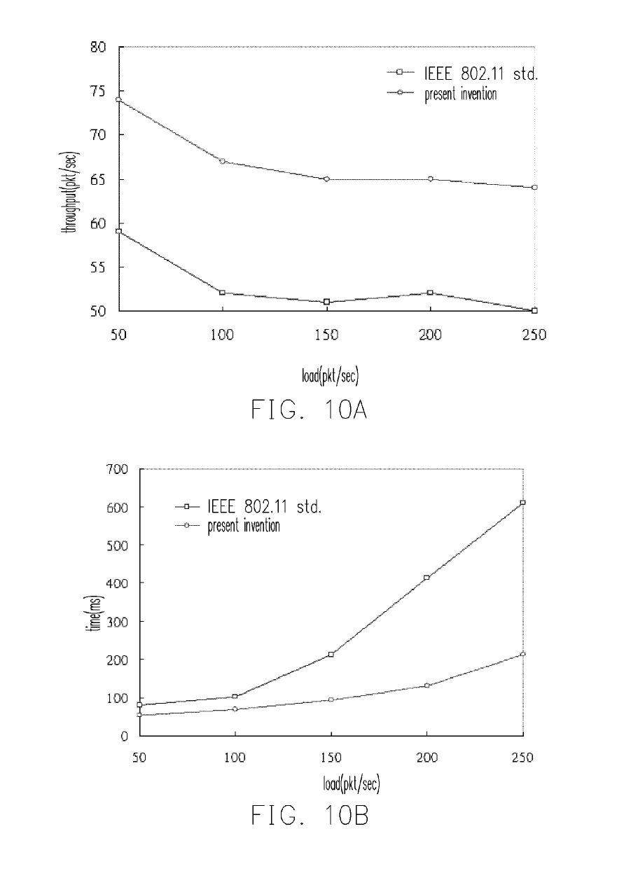

End-to-end throughput and end-to-end time delay, which are simulated and obtained in linear topology network environment, are respectively shown in FIGS. 8A and 8B. End-to-end throughput and end-to-end time delay, which are simulated and obtained in interlace topology network environment are respectively shown in FIGS. 9A and 9B. End-to-end throughput and end-to-end time delay, which are simulated and obtained in lattice topology network environment are respectively shown in FIGS. 10A and 10B. From the figures, it is understood that the methods of the present invention substantially increase the packet transmission speed.

In summary, the present invention decreases the packet transmitting time delay caused by the channel competition. In addition, the transmission of the control packet and the data are performed in different channels to reduce transmission collision of the packet. Therefore, the packet transmission speed can be improved.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

What is claimed is:

1. A packet transmitting method for WLAN, for transmitting data between a data transmitting node and a data receiving node; the packet transmitting method for WLAN comprising:
sending a transmitting request signal from the data transmitting node;
when the data receiving node receives the transmitting request signal and cannot immediately perform a transmitting operation defined by the transmitting request signal, the data receiving node sending a stop-transmitting signal to the data transmitting node;
after sending the stop-transmitting signal, the data receiving node sending a start-to-transmit signal to the data transmitting node when the transmitting operation can be performed; and
after receiving the start-to-transmit signal, the data transmitting node starts sending the data to the data receiving node.

2. The packet transmitting method for WLAN of claim 1, wherein when the data receiving node receives a plurality of transmitting request signals sent by the data transmitting nodes, the packet transmitting method for WLAN further comprises:
the data receiving node storing the transmitting request signals;
rearranging the transmitting operations defined by the transmitting request signals in order;
according to the rearranged order, sending back the start-to-transmit signal to one of the corresponding data transmitting nodes.

3. The packet transmitting method for WLAN of claim 2, wherein steps of rearranging the order of transmitting operation defined by the transmitting request signals comprise:
according to the sequence of the received transmitting request signals, placing corresponding addresses of the data transmitting nodes in queue in a first-in-first-out manner.

4. The packet transmitting method for WLAN of claim 1, wherein the transmitting request signal, the stop-transmitting signal, and the start-to-transmit signal are transmitted through the same wireless channel, and the data is transmitted through another wireless channel.

5. The packet transmitting method for WLAN of claim 1, wherein the channel of transmitting the data from the data transmitting node to the data receiving node is different from that of transmitting another data at the same time from the data receiving node to a next node.

6. The packet transmitting method for WLAN of claim 1, characterized in that the stop-transmitting signal does not comprise a network allocation vector NAV.

7. A controlling method for data transmitting node of WLAN, suitable for a data transmitting node for transmitting data; the controlling method for data transmitting node of WLAN comprising:
sending a transmitting request signal;
when receiving a start-to-transmit signal allowing for data transmission within a pre-determined time period, starting the data transmission; and
when receiving a stop-to-transmit signal disallowing the data transmission within a pre-determined time period, holding until the start-to-transmit signal is received to transmit data.

8. The controlling method for data transmitting node of WLAN of claim 7, further comprising:
activating a clock program of transmitting control packet; and
sending the transmitting request signal after a time counting process by the clock program is over.

9. The controlling method for data transmitting node of WLAN of claim 8, wherein when not receiving the start-to-transmit signal and the stop-transmitting signal within a pre-determined time period, the clock program is re-activated, and the transmitting request signal is set out again after a time counting process by the clock program is over.

10. A controlling method for data receiving node of WLAN, suitable for a data receiving node of receiving data, wherein the controlling method for data receiving node of WLAN comprises:
receiving a transmitting request signal;
when a transmitting operation defined by the transmitting request signal is not able to be processed, sending a stop-transmitting signal to disallow the data transmission;
when the transmitting operation is able to be processed, sending a start-to-transmit signal to allow the data transmission; and
after sending the start-to-transmit signal, waiting to receive the data.

11. The controlling method for data receiving node of WLAN of claim 10, wherein after sending the stop-transmitting signal, the method further comprises:
rearranging the transmitting operation with other transmitting operation in order through a sequencing mechanism; and
sequentially performing the rearranged transmitting operation.

12. The controlling method for data receiving node of WLAN of claim 11, wherein the sequencing mechanism rearranges the order according to a time delay bound and a class of service.

13. The controlling method for data receiving node of WLAN of claim 10, wherein whether or not the transmitting operation is performed is decided at a time period before a default band is in idle, wherein the time period is the time required for sending the start-to-transmit signal.
